(19) United States
(12) Patent Application Publication
(10) Pub. No.: US 2016/0115869 A1
(43) Pub. Date: Apr. 28, 2016

(54) METHOD FOR OPERATING A COMBINED CYCLE POWER PLANT

(71) Applicant: SIEMENS AKTIENGESELLSCHAFT, Munich (DE)

(72) Inventors: Matthias Migl, Munich (DE); Norbert Pieper, Dinslaken (DE)

(73) Assignee: Siemens Aktiengesellschaft, Munich (DE)

(21) Appl. No.: 14/892,276

(22) PCT Filed: May 21, 2014
(86) PCT No.: PCT/EP2014/060393

§ 371 Date: Nov. 19, 2015

(30) Foreign Application Priority Data
May 27, 2013 (EP) 13169386.3

(51) Int. Cl. F02C 6/18; F02C 7/26; F01K 23/06

(52) U.S. Cl. CPC F02C 6/18; F01K 23/06; F02C 7/26

(57) ABSTRACT

A method for operating a combined cycle power plant includes additional burners being arranged in the waste heat boiler, the burners being supplied with secondary air from the gas turbine, the gas turbine is operated without a supply of fuel, and driving is effected by means of a start-up inverter. A plant includes a waste heat boiler, additional burners for generating thermal energy being arranged within the waste heat boiler, a gas turbine designed such that the necessary air mass flow for the additional burners can be supplied by the gas turbine, wherein the gas turbine is operated without a supply of fuel, the plant further including a start-up inverter, wherein driving is effected by means of the start-up inverter.

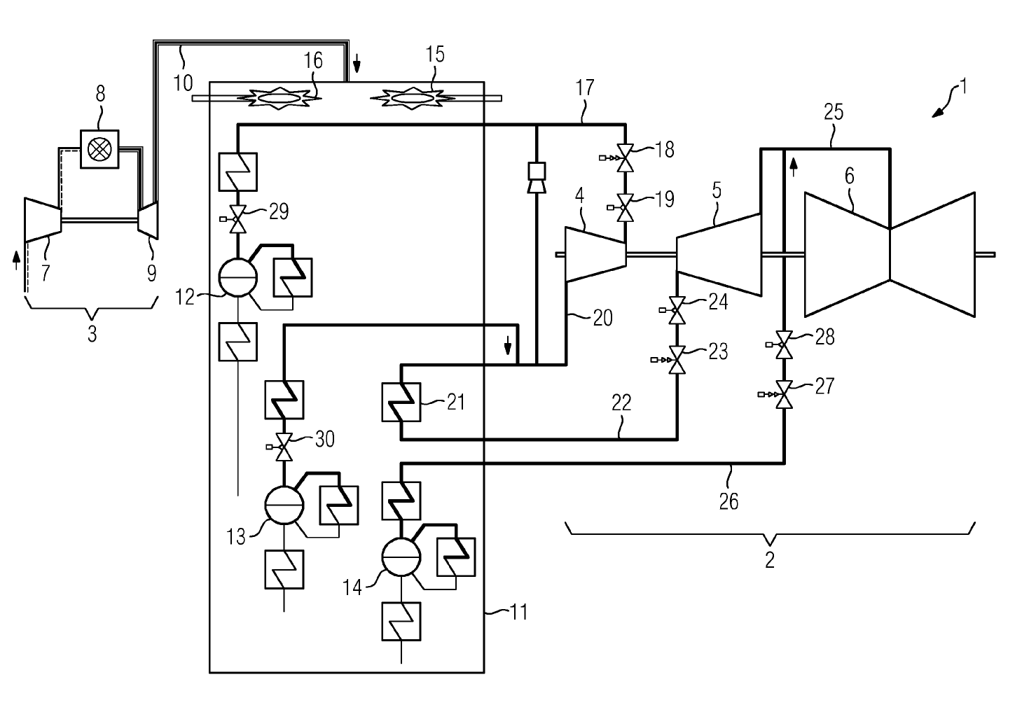

### CROSS REFERENCE TO RELATED APPLICATIONS

This application is the US National Stage of International Application No. PCT/EP2014/060393 filed May 21, 2014, and claims the benefit thereof. The International application claims the benefit of European Application No. EP13169386 filed May 27, 2013. All of the applications are incorporated by reference herein in their entirety.

### FIELD OF INVENTION

The invention relates to a plant comprising a waste heat boiler and to a method for operating a combined cycle power plant.

### BACKGROUND OF INVENTION

In addition to pure steam power plants, combined cycle plants are used for generating electrical power. In combined cycle plants, both a gas turbine and a steam turbine are used as rotating machines which drive one (in the case of single-shaft plants) or more (in the case of multiple-shaft plants) generators.

Furthermore, combined cycle plants are characterized in that the thermal energy at the outlet of the gas turbine is used for generating steam for the steam turbine.

Combined cycle plants having a gas turbine, in particular multiple gas turbines and a steam turbine, are usually operated in a load range between 25% and 100% of the rated power. The lower the power at which the gas turbine is operated, the lower also the thermal energy at the outlet of the gas turbine, which has a negative effect on the generation of the steam for the steam turbine. Below 50% of the rated power, a gas turbine with the associated waste heat boiler is usually stopped. In order to be able to run the gas turbine at low loads, in particular park loads, this is then possible only if the ratio between the fuel to be supplied to the gas turbine and the air required for the fuel is reduced. However, this leads to lower gas turbine exhaust gas temperatures and thus to lower temperatures of the steam for the steam turbine. Consequently, the thick-walled components of the steam turbine would cool down, leading to an increase in the time required for a subsequent increase in load.

Furthermore, on account of the then lower combustion temperatures in the gas turbine, the carbon dioxide (CO) values would increase markedly.

In addition to the generation of electrical power with corresponding active power, it is increasingly more important for conventional power plants such as combined cycle plants to have further properties. It is thus important for such combined cycle plants to have a power reserve for frequency stability. Furthermore, the combined cycle plants should have the possibility of generating sufficient reactive power for voltage stability in the grid and should have rotating masses in order to damp frequency variations in the electrical grid. In addition to conventional power plants, there exist plants for generating electrical power that are operated with renewable energy. Examples of these are wind turbines and photovoltaic plants. However, such plants cannot comply with the above-mentioned properties. It must however be assumed that the provision of power reserves and reactive power could in principle also be possible with these plants. The damping effect of rotating masses on the regulating objective or for frequency regulation can in principle only be provided by turbines such as for example a gas turbine or a steam turbine. Steam turbines are particularly suitable for this. This is due to the fact that the rotors of steam turbines have a high mass moment of inertia and also to the fact that the power of steam turbines in a certain value range is nigh independent of the rotational speed. By contrast, the power of a gas turbine at higher rotational speeds is also higher.

It is therefore advantageous if the steam turbine in a combined cycle plant is maintained in operation in the event of a minimum load on the grid. This would for example be the case if the demand for current is low or if large quantities are available from renewable sources.

However, currently, for example in Germany, most combined cycle power plants are stopped at night and are started again the next morning by means of a hot start. Alternatively, the gas turbine is run down to a minimum power and in that context the waste heat boiler and the steam turbine are run cold, which uses up an increased amount of the service life of the thick-walled components of the waste heat boiler and of the steam turbine. The minimum power at which such a combined cycle plant can be operated is limited by the permitted limit value for CO emissions.

### SUMMARY OF INVENTION

An object of the invention is to provide a plant permitting a better mode of operation.

This object is achieved with a plant as claimed.

This object is further achieved with a method as claimed.

It is thus proposed, according to the invention, that the steam turbine and at least one waste heat boiler is kept hot at minimum load. In that context, the gas turbine is not in the load range but provides the necessary air mass flow by means of the compressor section. In the case of combined cycle plants with two gas turbines, at least one of the two gas turbines provides the necessary air mass flow by means of the compressor section. The gas turbine is operated at a reduced rotational speed, with the start-up inverter driving the rotor of the gas turbine.

Advantageous developments are specified in the dependent claims.

In one advantageous development, the plant comprises a steam turbine which can be supplied with steam from the waste heat boiler, wherein the waste heat boiler has a high-pressure drum and a high-pressure pressure-maintaining valve is arranged downstream of the high-pressure drum. Accordingly, one advantageous development of the plant presents an intermediate-pressure drum which is arranged in the waste heat boiler, and an intermediate-pressure pressure-maintaining valve is arranged downstream of the intermediate-pressure drum.

The required secondary air for the burners is supplied in the waste heat boiler. The gas turbine should then be maintained at a rotational speed which approximately corresponds to the air mass flow which is required for the operation of the burners.

The fuel is fed into the additional burners arranged in the waste heat boiler. The fuel-air ratio is used to control the gas temperature such that the temperatures achieved on the steam side are close to the rated temperatures.

The turbine valves immediately upstream of the steam turbine should in this context be fully open. The additional valves which are arranged downstream of the steam drums should be used to keep the pressure in the evaporators at a constant pressure which can for example be 60% of the rated pressure but can also be between 40% and 100% of the rated pressure.

Advantageously, the steam turbine can thus be kept on the grid at a minimum load of for example less than 10 MW. The thick-walled components of the steam turbine and of the waste heat boiler remain approximately at their rated temperature. It is thus possible for load to be taken up again very rapidly.

Advantageously, the gas turbine is operated at rotational speeds of less than 30 Hz.

The above-described properties, features and advantages of this invention and the manner in which they are achieved become more clearly and distinctly comprehensible in conjunction with the following description of the exemplary embodiments which are explained in more detail in connection with the drawings.

Exemplary embodiments of the invention will be described hereinbelow with reference to the drawings. These drawings are not intended to illustrate the exemplary embodiments true to scale; rather, the drawing, where used for explanatory purposes, is schematic and/or slightly distorted. With regard to additions to the teaching which is directly apparent in the drawing, reference is made to the relevant prior art.

### BRIEF DESCRIPTION OF THE DRAWINGS

The FIGURE shows, schematically, a combined cycle plant according to the invention.

### DETAILED DESCRIPTION OF INVENTION

The FIGURE shows a combined cycle plant 1 comprising a steam turbine 2 and a gas turbine 3. In this context, the steam turbine 2 comprises a high-pressure turbine section 4, an intermediate-pressure turbine section 5 and a two-flow low-pressure turbine section 6.

The gas turbine 3 comprises a compressor section 7, a burner section 8 and a turbine section 9. The hot exhaust gas 10 of the gas turbine 3 passes into a waste heat boiler 11. This waste heat boiler 11 comprises a high-pressure drum 12, an intermediate-pressure drum 13 and a low-pressure drum 14. At least one additional burner 15 is arranged in the waste heat boiler 11. The waste heat boiler 11 shown in the FIGURE comprises, in addition to the additional burner 15, a further additional burner 16. The additional burner 15 and the additional burner 16 are designed to generate thermal energy and lead to steam for the steam turbine 2 being generated in the waste heat boiler 11.

To that end, there is arranged a fresh steam line 17 in which there are arranged valves 18 and 19 and which supplies the high-pressure turbine section 4 with fresh steam. The steam flows out of the high-pressure turbine section 4 via a waste steam line 20 to an intermediate superheater 21. In addition, the waste steam line 20 is supplied with steam by the one intermediate-pressure drum 13. Finally, steam enters the intermediate-pressure turbine section via an intermediate-pressure line 22 and via further valves 23 and 24. At the outlet of the intermediate-pressure turbine section 5, the steam passes toward the low-pressure turbine section 6 via an overflow line 25. In addition, the low-pressure turbine section 6 is supplied with steam by the low-pressure drum 14 in the waste heat boiler 11. Moreover, further valves 27 and 28 are arranged at the outlet of the low-pressure drum 14 in the low-pressure drum line 26.

The gas turbine 3 is designed such that the necessary air mass flow for the burners 15, 16 can be supplied by the gas turbine 3. This is brought about by virtue of the fact that the gas turbine 3 is operated without a supply of fuel, and driving is effected by means of a start-up inverter (not shown). For that reason, the burners 15, 16 are supplied with secondary air from the gas turbine 3. A high-pressure pressure-maintaining valve 29 is arranged downstream of the high-pressure drum 12. The high-pressure pressure-maintaining valve 29 is in this case operated such that the pressure in the waste heat boiler 11 is held at a constant pressure of 40%-100%, in particular 60% of the rated pressure. Moreover, the waste heat boiler 11 comprises an intermediate-pressure pressure-maintaining valve 30, wherein the intermediate-pressure turbine section 5 is supplied with intermediate-pressure steam via the intermediate-pressure drum 13 in the waste heat boiler 11, and an intermediate-pressure pressure-maintaining valve 30 is arranged downstream of the intermediate-pressure drum 13, wherein the intermediate-pressure pressure-maintaining valve 30 is operated such that the pressure in the waste heat boiler 11 is held at a constant pressure of 40%-100%, in particular 60% of the rated pressure. In that context, a high-pressure valve 18, 19 is arranged upstream of the high-pressure turbine section 4 and is fully open. The valves 24 and 23 are arranged upstream of the intermediate-pressure turbine section 5 and are fully open in this operating mode.

Thus, the operating mode of this combined cycle plant is operated such that the gas turbine 3 need not be synchronized with the grid but rather is designed as an air supply for the burners 15 and 16. Furthermore, the valves 30 and 29 ensure that the high-pressure drum 12 and the intermediate-pressure drum 13 can be held approximately at their rated pressures and thus approximately at their rated temperatures.

It is thus possible to operate at minimum park load, maintaining grid-stabilizing properties in the process. This is effected for example by providing reactive power or by damping by means of rotating masses. From this state, the plant 1 can be brought up to its rated power more rapidly. In particular if it were necessary to shut down the combined cycle plant 1 for a longer time.

Although the invention has been described and illustrated in more detail by way of the preferred exemplary embodiment, the invention is not restricted by the disclosed examples and other variations can be derived herefrom by a person skilled in the art without departing from the scope of protection of the invention.

1. A plant comprising
a waste heat boiler,
additional burners for generating thermal energy being arranged within the waste heat boiler,
a gas turbine adapted such that the necessary air mass flow for the additional burners can be supplied by the gas turbine,
wherein the gas turbine is operated without a supply of fuel,
the plant further comprising a start-up inverter, wherein driving is effected by means of the start-up inverter.

2. The plant as claimed in claim 1, further comprising
a steam turbine adapted to be supplied with steam from the waste heat boiler,
wherein the waste heat boiler has a high-pressure drum and a high-pressure pressure-maintaining valve is arranged downstream of the high-pressure drum.

3. The plant as claimed in claim 2,
wherein the waste heat boiler has an intermediate-pressure drum and an intermediate-pressure pressure-maintaining valve is arranged downstream of the intermediate-pressure drum.

4. A method for operating a combined cycle power plant, wherein an additional burner is arranged in the waste heat boiler and is adapted to be supplied with secondary air from the gas turbine, the method comprising:
operating the gas turbine without a supply of fuel, and
effecting driving by means of a start-up inverter.

5. The method as claimed in claim 4,
wherein the gas turbine is operated at a reduced rotational speed.

6. The method as claimed in claim 5,
wherein the gas turbine is operated at rotational speeds of less than 30 Hz.

7. The method as claimed in claim 4, further comprising:
supplying a high-pressure turbine section with fresh steam via a high-pressure drum in the waste heat boiler, and
arranging a high-pressure pressure-maintaining valve downstream of the high-pressure drum.

8. The method as claimed in claim 7,
wherein the high-pressure pressure-maintaining valve is operated such that the pressure in the waste heat boiler is held at a constant pressure of 40%-100% of the rated pressure.

9. The method as claimed in claim 4, further comprising:
supplying an intermediate-pressure turbine section with intermediate-pressure steam via an intermediate-pressure drum in the waste heat boiler, and
arranging an intermediate-pressure pressure-maintaining valve downstream of the intermediate-pressure drum.

10. The method as claimed in claim 9,
wherein the intermediate-pressure pressure-maintaining valve is operated such that the pressure in the waste heat boiler is held at a constant pressure of 40%-100% of the rated pressure.

11. The method as claimed in claim 7, further comprising:
arranging a high-pressure valve upstream of the high-pressure turbine section which is fully open.

12. The method as claimed in claim 9, further comprising:
arranging an intermediate-pressure valve upstream of the intermediate-pressure turbine section which is fully open.

13. The method of claim 8,
wherein the constant pressure is 60% of the rated value.

14. The method of claim 10,
wherein the constant pressure is 60% of the rated value.
